(19) United States
(12) Patent Application Publication
(10) Pub. No.: US 2021/0106071 A1
(43) Pub. Date: Apr. 15, 2021

(54) KNITTED FOOT GARMENT AND METHOD FOR TREATING A KNITTED FOOT GARMENT

(71) Applicant: Arnold Bookoff, Timonium, MD (US)

(72) Inventor: Arnold Bookoff, Timonium, MD (US)

(21) Appl. No.: 17/069,296

(22) Filed: Oct. 13, 2020

Related U.S. Application Data
(60) Provisional application No. 62/913,839, filed on Oct. 11, 2019.

(51) Int. Cl. A41B 11/00; B32B 5/02; B32B 27/28; B32B 27/12; B32B 3/10

(52) U.S. Cl. CPC A41B 11/007; B32B 5/026; B32B 27/28; B32B 2437/00; B32B 3/10; A41B 2500/10; A41B 2500/50; B32B 27/12

(57) ABSTRACT

A method for treating a knitted foot garment that provides added cushion to the knitted material of the sock includes the steps of heating a liquid polymer mixture, forcing gas into the mixture, agitating the mixture to create a bubble infused mixture, injecting the bubble infused mixture into a polymer template, attaching the polymer template to the outer sole of a knitted foot garment, and cooling the gas infused polymer mixture. A knitted foot garment includes upper, heel, toe, and sole knitted fabric portions integrally woven together to define a chamber. A plurality of encapsulated polymer pads are attached to and protrude from an outer surface of either the heel, toe or sole portions. The polymer pads contain gas bubbles to provide increased cushioning to the sole of the foot garment.

This application claims the benefit of U.S. provisional patent application No. 62/913,839 filed Oct. 11, 2019.

### BACKGROUND OF THE DISCLOSURE

The present disclosure relates to foot garments and more specifically to knitted foot garments with increased cushioning.

Knitted foot garments, also referred to herein as socks, are used to protect and/or warm an individual's foot. They are made from a range of fibrous material, whether naturally occurring, such as cotton or wool, or synthetic, such as acrylic or polyester. Further, socks are made for a number of different reasons. Some are formed of thick material for providing extra warmth in cold weather or for providing extra cushioning for extensive walking and/or standing. Some are specifically manufactured for athletic undertakings, often including materials that have sweat and/or odor reducing qualities. Socks can be long and cover a person's leg, or be short, covering only the portion of the foot that will be inserted into a shoe.

Of the many potential features of a sock, providing comfort to a user is one of the most important. Attempts to provide more comfort from a sock typically include providing extra material on the sole of a sock or stitched padding in heavily used regions, such as the heal or ball of one's foot. Often times, however, these methods do not provide the comfort one needs, and thus other measures must be taken to provide sufficient comfort. One such measure may be in the form of extra cushioning within a shoe, whether incorporated in the manufacturing process or with after-market padded insoles. The drawback with this measure is that the cushioning within a shoe is only provided while wearing a shoe.

Therefore, there is a need for knitted foot garments, such as socks, that provide greater comfort to the sole of a user than those currently offered.

### SUMMARY OF THE DISCLOSURE

Accordingly, it is an object of the present disclosure to provide a method for treating a knitted foot garment that provides added cushioning to the knitted material of a sock. This includes the steps of heating a liquid polymer mixture, forcing gas into the mixture, agitating the mixture to infuse bubbles therein, injecting the bubble infused mixture into a polymer template, attaching the polymer template to the outer sole of a knitted foot garment, and cooling the gas infused polymer mixture. Preferably, the template is attached to the toe, ball, arch and/or heel portions of the knitted foot garment.

It is a further object of the present disclosure to provide a knitted foot garment that includes upper, heel, toe, and sole knitted fabric portions integrally woven together to define a chamber. In addition, a plurality of encapsulated polymer pads are attached to and protrude from the outer surface of either the heel, toe or sole portions. The polymer pads contain gas bubbles to provide increased cushioning to the sole of the foot garment. Preferably, the polymer pads include a silicone gel mixture and are configured to generally correspond with the contours of the heel, toe, ball and arch portions of a foot.

### BRIEF DESCRIPTION OF THE FIGURES

FIG. 1 is a flow chart showing steps for treating a knitted foot garment according to the present disclosure;

FIG. 2 is a perspective view of knitted foot garments according to the present disclosure;

FIG. 3 is a front view of the sole of the embodiment in FIG. 3; and

FIG. 4 is a perspective view of a portion of the sole in FIG. 4.

### DETAILED DESCRIPTION

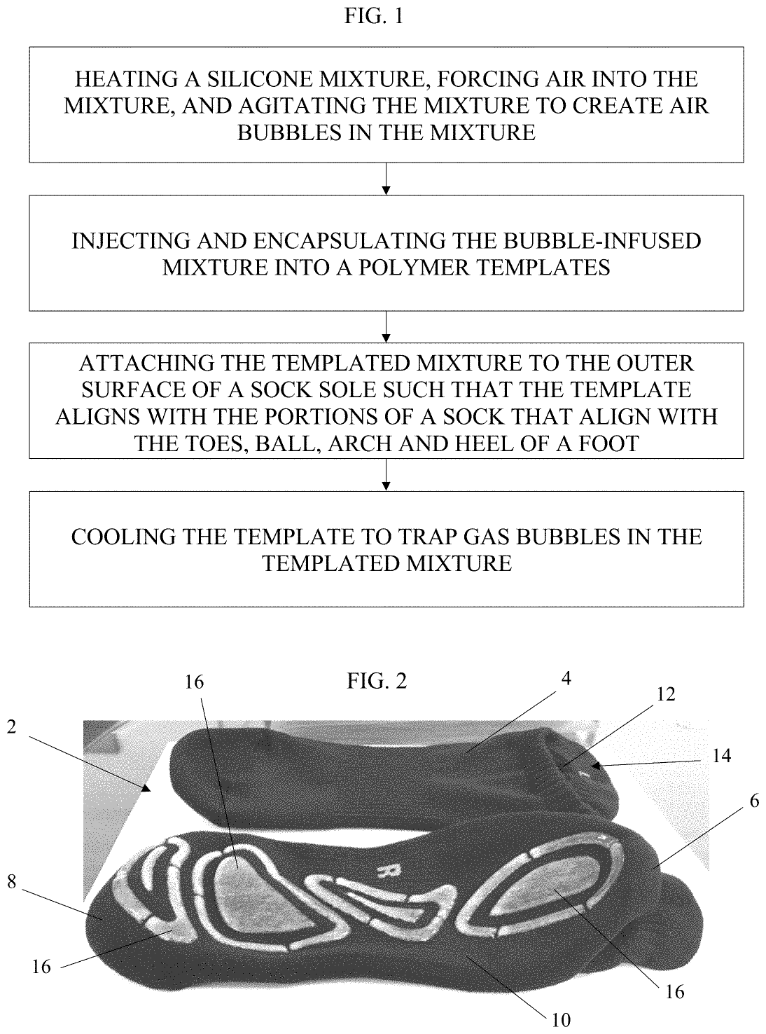

Referring first to FIG. 1, a flow chart shows a method for treating a knitted foot garment. The method includes heating a liquid polymer mixture, such as a silicone gel, forcing gas into the mixture, and agitating the mixture to create a bubble infused mixture. Once the bubble infused mixture is created, it is injected into a polymer template, which is attached to the outer sole of a knitted foot garment. The mixture is cooled to trap the bubbles in an encapsulated pad on the garment. The gas infused bubbles results in cushioning on the bottom of a foot garment, which provides more cushioning than with standard polymer templates that do not include the gas bubbles.

Referring now to FIGS. 2-4, an embodiment of a knitted foot garment 2 is shown. It includes upper 4, heel 6, toe 8, and sole 10 portions, each of which are integrally woven together to define an inner chamber 12. The upper contains an opening 14 through which a foot is inserted. There are a plurality of encapsulated polymer pads 16 attached to and protruding from the outer surface of at least one of the heel 6, toe 8 and sole 10 portions of the garment. The pads are made of a silicone gel mixture and are configured to correspond with the contours of the heel, toe, ball and arch portions of a foot.

To create the pads, the template 16 is first attached to the garment 2, the silicone mixture is then injected into the template directly on the garment, and the mixture is cooled to finalize the process. It will be understood by those with skill in the art that other methods for attaching the silicone pads to the foot garment could be used, for instance, by first injecting the liquid into the template and then attaching the polymer filled template onto the garment.

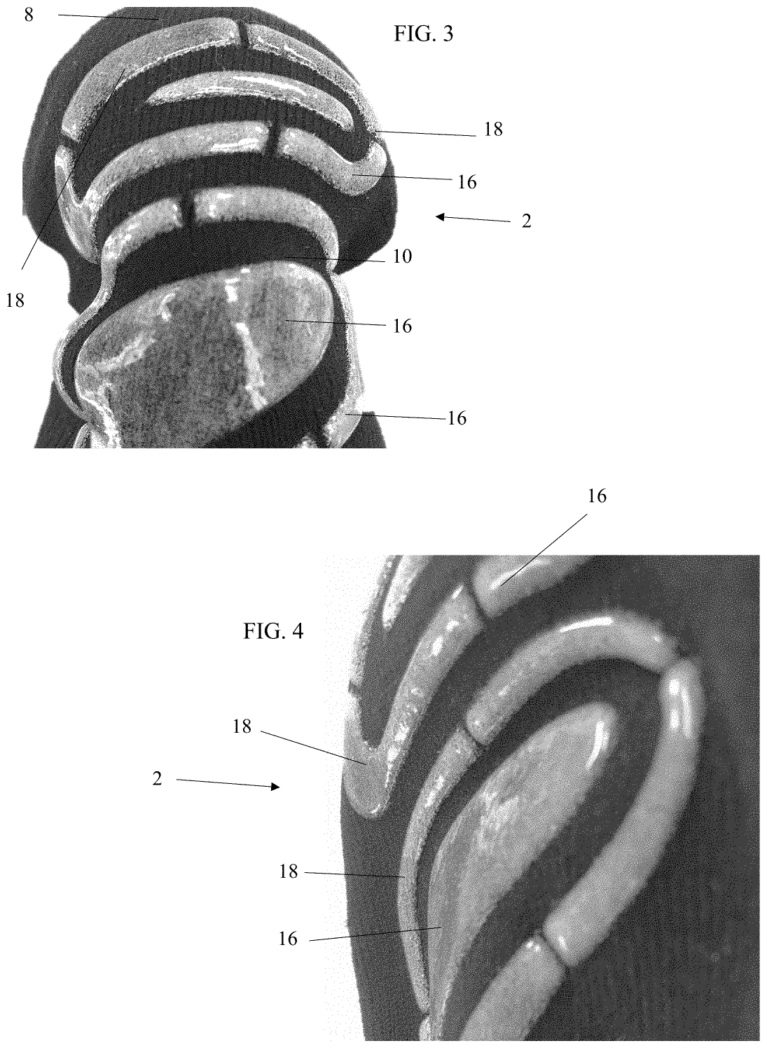

As shown in FIGS. 3 and 4, the silicone mixture 16 include a plurality of bubbles 18, which are formed by forcing gas into a hot silicone mixture, agitating the mixture to form the bubbles, and encapsulating the mixture within the template to trap the bubbles in the pads. The addition of bubbles to the mixture provides increased cushioning over the silicone alone.

It will be understood by those with skill in the art that other liquid polymers could be used in the place of silicone, and a range of gasses could be used to provide the bubbles. Further, the pads can be arranged in different configurations with more or less pads depending on the desired level of cushion on the sole of the garment.

Although the above description with reference to particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed is:

1. A method for treating a knitted foot garment, comprising the steps of:
(a) forcing gas into a liquid polymer mixture;
(b) agitating the mixture to create a bubble infused mixture;
(c) injecting the bubble infused polymer mixture into a polymer template; and
(d) attaching the polymer template to the outer sole of a knitted foot garment.

2. A method for treating a knit fabric foot garment as defined in claim 1, and further comprising the steps of:
(a) heating the polymer mixture prior to forcing gas into the mixture; and
(b) cooling the gas infused polymer mixture after the polymer template is applied to a knitted foot garment to trap gas bubbles within the mixture.

3. A method for manufacturing a knit fabric foot garment as defined in claim 2, wherein said attaching step includes attaching the template to the toe, ball, arch and heel portions of the knitted foot garment.

4. A knitted foot garment, comprising:
(a) upper, heel, toe, and sole knitted fabric portions integrally woven to define a chamber, said upper containing an opening configured to receive a foot; and
(b) a plurality of encapsulated polymer pads attached to an outer surface of one of said heel, toe and sole portions and protruding therefrom, said polymer pads containing gas bubbles to provide increased cushioning to the sole of the foot garment.

5. A knitted foot garment as defined in claim 4, wherein said polymer pads comprise a polymer gel.

6. A knit fabric foot garment as defined in claim 4, wherein said polymer pads comprise a silicone gel mixture.

7. A knit fabric foot garment as defined in claim 5, wherein said encapsulated silicone polymer pads are configured to generally correspond with the contours of the heel, toe, ball and arch portions of a foot.
